(19) United States
(12) Patent Application Publication
(10) Pub. No.: US 2026/0029196 A1
(43) Pub. Date: Jan. 29, 2026

(54) TUYERE SLEEVE FOR HYDROGEN-ENRICHED CARBONIC OXIDE RECYCLING OXYGENATE FURNACE AND CONTROLLING METHOD THEREFOR

(71) Applicant: XINJIANG BAYI IRON & STEEL CO., LTD., Urumqi (CN)

(72) Inventors: Baoshan TIAN, Urumqi (CN); Yansong MA, Urumqi (CN); Lei LIU, Urumqi (CN); Wanneng YUAN, Urumqi (CN); Xiaobing XU, Urumqi (CN)

(21) Appl. No.: 18/976,347

(22) Filed: Dec. 11, 2024

Related U.S. Application Data
(63) Continuation of application No. PCT/CN2024/127497, filed on Oct. 25, 2024.

(30) Foreign Application Priority Data
Jul. 24, 2024 (CN) 202410994681.1

(51) Int. Cl. F27B 1/16; C21B 7/16; F27B 1/26

(52) U.S. Cl. CPC F27B 1/16; C21B 7/16; F27B 1/26

(57) ABSTRACT

A tuyere sleeve for hydrogen-enriched carbonic oxide recycling oxygenate furnace includes a tuyere body, a front surface of the tuyere sleeve, and an oxygen channel. The front end is welded to a front welding interface with the front surface. The oxygen channel is defined inside the tuyere body, and the oxygen channel extends from an inner side of the front surface of the tuyere sleeve. The oxygen outlet is located at a distance of 20 mm-50 mm from the tuyere front surface, and an angle between the oxygen outlet and a centerline of the tuyere sleeve is in a range of 25°-30°. During a normal operation, controlling an oxygen flow rate in oxygen outlet to be not less than 150 m/s, and controlling a distance between a front high-temperature zone and a front surface to be not less than 200 mm.

### CROSS-REFERENCE TO RELATED APPLICATIONS

This application is a continuation of International Patent Application No. PCT/CN2024/127497, filed Oct. 25, 2024, which claims priority to Chinese Patent Application No. 202410994681.1, filed Jul. 24, 2024, which is herein incorporated by reference in its entirety.

### TECHNICAL FIELD

The disclosure relates to the technical field of blast furnace smelting, and particularly to a tuyere sleeve for hydrogen-enriched carbonic oxide recycling oxygenate furnace and a controlling method therefor.

### BACKGROUND

Seventy percent of the energy consumption in iron and steel enterprises is concentrated in the ironmaking process, hence reducing carbon consumption in the ironmaking process is the main approach to achieving coal reduction in the iron and steel industry. The traditional blast furnace process, which has been developed for hundreds of years, is characterized by high thermal efficiency, large production scale, and mature technology. However, it has also reached a development bottleneck, the space for further reduction in fuel consumption of molten iron is limited, and the large-scale blast furnace has approached its limit in improving production efficiency.

The hydrogen-enriched carbonic oxide recycling oxygenate furnace (HyCROF) adopts all-oxygen smelting and top gas decarbonization heating recycling technology, which reduces the consumption of fossil energy in traditional blast furnace processes by 30%. However, due to the characteristics of the all-oxygen smelting and gas heating back-injection processes, the blast furnace tuyeres are highly susceptible to melting damage in the complex working environment of high temperatures, oxidation, coal powder injection, and high-temperature molten slag and iron inside the furnace, thereby affecting the normal operation of the blast furnace.

### SUMMARY

The disclosure provides a tuyere sleeve for hydrogen-enriched carbonic oxide recycling oxygenate furnace and a controlling method therefor, in order to solve the problem of easy melting and damage of the tuyere of the hydrogen-enriched carbonic oxide recycling oxygenate furnace.

To achieve above purpose, a tuyere sleeve for hydrogen-enriched carbonic oxide recycling oxygenate furnace is provided, and the tuyere sleeve includes a tuyere body, a tuyere front surface, and an oxygen channel. The tuyere body defines a high-temperature coal gas channel (i.e., coal gas channel) and a tuyere cooling water channel, the high-temperature coal gas channel is located at a center position of the tuyere body, the tuyere cooling water channel is located at a side of the tuyere body, and the front end of the tuyere body is welded to a front welding interface with the tuyere front surface.

A diameter of the high-temperature coal gas channel is in a range of 50 millimeters (mm)-120 mm. According to a size of the blast furnace and a gas flow rate at a tuyere, it is required that the gas flow rate at the tuyere should not be less than 150 m/s, and during high temperature normal load operation, the gas flow rate should not be less than 200 m/s.

To ensure that during production, the coal gas flow rate in the high-temperature coal gas channel above 1100° C. is not less than 200 m/s, the coal gas in the high-temperature coal gas channel can be selected as the blast furnace's own recirculating decarbonized gas, hydrogen-rich coke oven gas, or a mixture of the above two types of gas.

A total length of the tuyere sleeve is in a range of 6%-8% of an inner diameter of a blast furnace hearth. Specifically, an optimal length is 7% of the inner diameter of the blast furnace hearth. The blast furnace with a capacity of over 1000 cubic meters tend to take a lower limit value, while those with a capacity of under 1000 cubic meters tend to take the upper limit value.

The oxygen channel is defined inside the tuyere body, and the oxygen channel extends from an inner side of the front end of the tuyere body. The tuyere body defines an oxygen inlet and an oxygen outlet at two ends of the oxygen channel, respectively. The oxygen outlet is located at a distance of 20 mm-50 mm from the tuyere front surface, the oxygen outlet is located at an angle of 30°-45° below a horizontal line, and a distance from the oxygen outlet to a gun outlet of an inserted coal injection is greater than or equal to 50 mm; and an angle between the oxygen outlet and a tuyere centerline (also referred to as centerline of the tuyere sleeve) is in a range of 25°-30°.

The tuyere sleeve includes a tuyere body, a tuyere front surface, and an oxygen channel. The tuyere body defines a high-temperature coal gas channel and a tuyere cooling water channel, the high-temperature coal gas channel is located at a center position of the tuyere body, which is to ensure that the coal gas smoothly pass through the tuyere sleeve. The tuyere cooling water channel is located at a side of the tuyere body, which is to cool down the tuyere sleeve and avoid high-temperature melting. The oxygen channel is defined inside the tuyere body, and the oxygen channel extends from an inner side of the front end of the tuyere body. A distance and an oxygen injection angle between the oxygen outlet of the oxygen channel and the tuyere front surface are set to avoid high-temperature reactions between the oxygen and the coal gas that may cause melting damage to the tuyere sleeve, ensuring the safe and stable operation of the tuyere area of the hydrogen-enriched carbonic oxide recycling oxygenate furnace.

In an embodiment, a distance between the front welding interface and the oxygen outlet is not less than 20 mm, and a weld depth of the front welding interface is not less than 20 mm.

The oxygen channel and the tuyere body are integrally cast in one piece, and after forming, they are welded to the tuyere front surface. The welding material must be chosen to have a thermal conductivity not lower than that of the base material, and it must pass a water pressure test of not less than 2 megapascal (Mpa).

By controlling the distance between the front welding interface and the oxygen channel, the problem of the front welding interface melting damage due to the distance being too close between the front welding interface and the oxygen channel can be avoided. Additionally, the weld depth of the front welding interface is increased, enhancing an ability of the front welding interface to withstand high temperatures.

In an embodiment, after a welding of the front welding interface is completed, a high-temperature and wear-resistant protective layer is welded to the front welding interface.

By adding the high-temperature and wear-resistant protective layer to the front welding interface, the protection of the front surface of the tuyere sleeve and a weld seam is completed, increasing the high-temperature resistance of the front welding interface.

A controlling method for a tuyere sleeve for hydrogen-enriched carbonic oxide recycling oxygenate furnace is also provided. The controlling method includes: during a normal operation, controlling an oxygen flow rate in an oxygen outlet to be not less than 150 meters per second (m/s), and controlling a distance between a front high-temperature zone of the tuyere body and a tuyere front surface to be not less than 200 mm. In addition, the flow rate deviation between the oxygen stream in the oxygen channel and the coal gas stream in the high-temperature gas channel should not exceed 30 m/s, thereby to keep the high-temperature zone away from the front surface of the tuyere sleeve.

By controlling the oxygen flow rate at the oxygen outlet and ensuring the distance of not less than 200 mm between the high-temperature zone at the front end of the tuyere body and the tuyere front surface, the high-temperature zone is kept away from the tuyere front surface. This prevents combustion reactions between the oxygen flow and the high-temperature coal gas flow in the tuyere area, which could cause high-temperature damage to the tuyere. As a result, it reduces the frequency of blast furnace outages and improves the efficiency of ironmaking in the blast furnace.

In an embodiment, the controlling method further includes: during an initial start-up or a load operation period, and under a condition of an oxygen supplying rate being lower than a preset normal value, controlling a number of the oxygen inlet to maintain an oxygen flow rate being not less than 150 m/s in the oxygen inlet, and introducing 100-300 m³/h of nitrogen gas into the oxygen inlet.

By controlling the number of the oxygen inlet and supplementing with the nitrogen gas, maintaining the oxygen flow velocity of not less than 150 m/s in the oxygen inlet ensures the safe and stable operation of the tuyere area in the hydrogen-enriched carbonic oxide recycling oxygenate furnace.

In an embodiment, the controlling method further includes: before introducing oxygen to the hydrogen-enriched carbonic oxide recycling oxygenate furnace, adjusting a heated coal gas or a heated nitrogen gas in a temperature coal gas channel to more than 40% of a total air volume, and adjusting an airflow velocity in the temperature coal gas channel being not less than 150 m/s.

Before introducing the oxygen into the blast furnace, by adjusting the wind volume of the heated coal gas or the heated nitrogen gas in the high-temperature coal gas channel and controlling the air flow rate within the high-temperature coal gas channel, a stable operation foundation is provided for the subsequent stable operation of the blast furnace tuyere area after the oxygen is introduced.

In an embodiment, the controlling method further includes: before introducing the oxygen to the hydrogen-enriched carbonic oxide recycling oxygenate furnace, first introducing the nitrogen gas of not being less than 500 m³/h into an oxygen channel, adding the oxygen into the oxygen channel, and maintaining an oxygen flow rate in the oxygen channel being not less than 150 m/s; when the oxygen in the oxygen channel increases to more than 70% of a set oxygen level, gradually releasing the nitrogen gas in the oxygen channel, and maintaining a total flow rate in the oxygen channel not being less than 150 m/s.

Before introducing the oxygen to the hydrogen-enriched carbonic oxide recycling oxygenate furnace, the nitrogen gas is first introduced into the oxygen channel, followed by adding the oxygen into the oxygen channel, and the oxygen flow rate within the oxygen channel is controlled. When the oxygen in the oxygen channel increases to more than 70% of the set oxygen level, the nitrogen gas is gradually released from the oxygen channel, ensuring the concentration of oxygen within the oxygen channel.

The disclosure provides a tuyere sleeve for hydrogen-enriched carbonic oxide recycling oxygenate furnace, and the tuyere sleeve includes a tuyere body, a tuyere front surface, and an oxygen channel. The tuyere body is welded to a front welding interface with the tuyere front surface, the oxygen channel is defined inside the tuyere body, and the oxygen channel extends from an inner side of the tuyere front surface. The oxygen outlet is located at a distance of 20 mm-50 mm from the tuyere front surface, and an angle between the oxygen outlet and the tuyere front surface is in a range of 25°-30°. The oxygen outlet is located at an angle of 30°-45° below a horizontal line, and a distance from the oxygen outlet to a gun outlet of an inserted coal injection is greater than or equal to 50 mm. During a normal operation of the blast furnace, an oxygen flow rate in the oxygen outlet is controlled to be not less than 150 m/s, the angle is used to match the flow rates and angles of the oxygen flow in the oxygen channel with the coal gas flow in the high-temperature coal gas channel. By keeping the high-temperature zone at the front end of the tuyere away from the tuyere front surface, using the tuyere sleeve for hydrogen-enriched carbonic oxide recycling oxygenate furnace and applying the controlling method, it is possible to effectively prevent damage to the blast furnace and improve the efficiency of ironmaking in the blast furnace.

### BRIEF DESCRIPTION OF DRAWINGS

FIG. 1 illustrates a schematic cross-sectional structure diagram of a tuyere sleeve for hydrogen-enriched carbonic oxide recycling oxygenate furnace of the disclosure.

FIG. 2 illustrates a schematic sectional plane structure diagram of the tuyere sleeve for hydrogen-enriched carbonic oxide recycling oxygenate furnace of the disclosure.

FIG. 3 illustrates a schematic sectional view of an oxygen outlet of an oxygen channel in the disclosure.

FIG. 4 illustrates a schematic sectional view of an oxygen inlet of the oxygen channel in the disclosure.

### DESCRIPTION OF REFERENCE NUMERALS

1. oxygen channel; 2. oxygen inlet; 3. oxygen outlet; 4. tuyere body; 5. high-temperature coal gas channel; 6. tuyere cooling water channel; 7. cooling water channel; 8. tuyere front surface; 9. front welding interface; 10. coal gas injection inlet; 11. cooling water inlet; 12. cooling water outlet; 13. tuyere sleeve fixing groove.

### DETAILED DESCRIPTION OF EMBODIMENTS

The disclosure will be further described in detail through specific embodiments.

### Embodiment 1

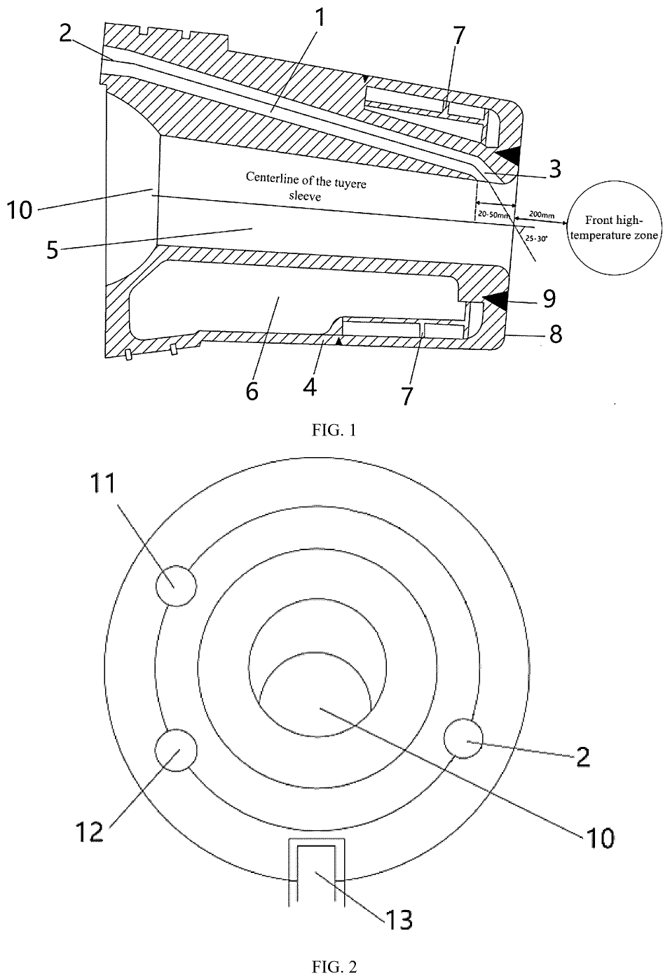

As shown in FIG. 1, a tuyere sleeve for hydrogen-enriched carbonic oxide recycling oxygenate blast furnace is provided, and the tuyere sleeve includes a tuyere body 4, a tuyere front surface 8, and an oxygen channel 1. The tuyere body 4 defines a high-temperature coal gas channel 5 and a tuyere cooling water channel 6, the temperature coal gas channel 5 is located at a center position of the tuyere body 4, and the tuyere cooling water channel 6 is located at a side of the tuyere body 4. A cooling water channel 7 is provided in the tuyere cooling water channel 6, and a cooling water channel 7 is also provided above the oxygen channel 1. A front end of the tuyere body 4 is welded to a front welding interface 9 with the tuyere front surface 8. A diameter of the high-temperature gas channel 5 is selected to be 50 mm. A total length of the tuyere sleeve is set to 6% of an inner diameter of a blast furnace hearth (a volume of the blast furnace is over 1000 cubic meters, hence the lower limit value is taken). In this setup, the high-temperature coal gas is introduced into the high-temperature coal gas channel 5 through the coal gas injection inlet 10.

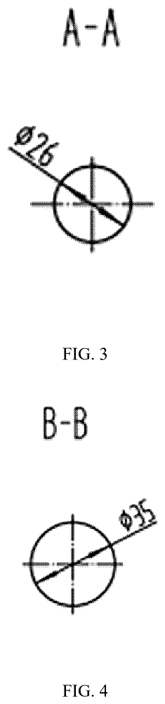

The oxygen channel 1 is defined inside the tuyere body 4, and the oxygen channel 1 extends from an inner side of the tuyere front surface 8. The tuyere body 4 defines an oxygen inlet 2 and an oxygen outlet 3 at two ends of the oxygen channel 1, respectively. The oxygen outlet 3 is located at a distance of 20 mm from the tuyere front surface 8, the oxygen outlet 3 is located at an angle of 30° below a horizontal line, and a distance from the oxygen outlet 3 to a gun outlet of an inserted coal injection is greater than or equal to 50 mm. An angle between the oxygen outlet 3 and a centerline of the tuyere sleeve is 25°. In addition, the oxygen channel 1 is formed by vacuum casting in one piece. The distance between the front welding interface 9 and the oxygen outlet 3 is 20 mm, and a weld depth of the front welding interface 9 is also 20 mm, as shown in FIGS. 3 and 4. The oxygen channel 1 is designed with a larger diameter at the oxygen inlet 2 and a smaller diameter at the oxygen outlet 3, that is, the oxygen inlet 2 is larger and the oxygen outlet 3 is smaller. The diameter of the oxygen inlet 2 can be chosen as 35 mm, and the diameter of the oxygen outlet 3 can be 26 mm.

To protect the tuyere front surface and a weld seam, the embodiment of the disclosure applies a layer of high-temperature resistant and wear-resistant protective layer on the front welding interface 9 after the tuyere front surface 8 and the tuyere body 4 are welded together.

FIG. 2 illustrates a left-side view planar schematic structure diagram of the tuyere sleeve for hydrogen-enriched carbonic oxide recycling oxygenate furnace, showing that a left side of the tuyere sleeve is defined with a cooling water inlet 11 and a cooling water outlet 12. The cooling water inlet 11 and cooling water outlet 12 are included in the tuyere cooling water channel 6, which is configured to introduce and output the cooling water. An upper part of the tuyere sleeve is defined with the oxygen inlet 2, a center of the tuyere sleeve is defined with the oxygen outlet 3, and a position slightly below the center of the tuyere sleeve is defined with a coal gas injection inlet 10. The high-temperature coal gas is introduced into the high-temperature coal gas channel 5 through the coal gas injection inlet 10. A lower part of the tuyere sleeve is defined with a tuyere sleeve fixing groove 13, which is configured to fix the tuyere sleeve.

The disclosure further provides a controlling method for a tuyere sleeve for hydrogen-enriched carbonic oxide recycling oxygenate blast furnace. The controlling method includes steps as follows.

During a normal operation of the hydrogen-enriched carbonic oxide recycling oxygenate furnace, an oxygen flow rate in an oxygen outlet 3 is controlled to be 150 m/s, and a distance between a front temperature zone of the tuyere body and a tuyere front surface is controlled to be 200 mm, which prevents combustion reactions between the oxygen flow and the high-temperature coal gas flow in the tuyere area, which could cause high-temperature damage to the tuyere. As a result, it reduces the frequency of furnace outages and improves the efficiency of ironmaking in the furnace.

During an initial start-up or a low load operation period, and under a condition of an oxygen supplying rate being lower than a preset normal value, a number of the oxygen inlet 2 is controlled to maintain an oxygen flow rate being 150 m/s in the oxygen inlet, and 100 m³/h of nitrogen gas are introduced into the oxygen inlet.

Before introducing oxygen to the hydrogen-enriched carbonic oxide recycling oxygenate furnace, a heated coal gas or a heated nitrogen gas in a high-temperature coal gas channel needs to be adjusted to more than 40% of a total air volume, and an airflow velocity in the high-temperature coal gas channel 5 need to be adjusted being not less than 150 m/s, which provides a foundation for the stable operation of the furnace tuyere area after subsequent oxygen supply.

Before the introducing the oxygen to the hydrogen-enriched carbonic oxide recycling oxygenate furnace, nitrogen gas of 500 m³/h are first introduced into an oxygen channel 1, then the oxygen is added into the oxygen channel 1, and an oxygen flow rate in the oxygen channel is maintained being not less than 150 m/s. When the oxygen in the oxygen channel 1 increases to more than 70% of a set oxygen level, the nitrogen gas in the oxygen channel is gradually released, and a total flow rate in the oxygen channel is maintained not being less than 150 m/s, which ensure a concentration of the oxygen in oxygen channel 1.

By utilizing the above tuyere sleeve for hydrogen-enriched carbonic oxide recycling oxygenate blast furnace and applying the controlling method, it is possible to effectively prevent furnace burnout and improve furnace ironmaking efficiency.

### Embodiment 2

The specific implementation method in embodiment 2 is the same as the embodiment 1, except for the following parts.

1. a diameter of the high-temperature coal gas channel 5 is 120 mm, and a total length of the tuyere sleeve is 8% of an inner diameter of a blast furnace hearth (a volume of the blast furnace is over 1000 cubic meters, hence the upper limit value is taken).

2. the oxygen outlet 3 is located at a distance of 30 mm from the tuyere front surface 8, the oxygen outlet 3 is located at an angle of 45° below a horizontal line, and a distance from the oxygen outlet 3 to a gun outlet of an inserted coal injection is 70 mm. An angle between the oxygen outlet 3 and a centerline of the tuyere sleeve is 30°.

3. the oxygen channel 1 is formed by vacuum casting in one piece. The distance between the front welding interface 9 and the oxygen outlet 3 is 40 mm, and a weld depth of the front welding interface 9 is also 40 mm.

4. During a normal operation of the hydrogen-enriched carbonic oxide recycling oxygenate furnace, an oxygen flow rate in an oxygen outlet 3 is controlled to be 170 m/s, and a distance between a front temperature zone of the tuyere body and a tuyere front surface is controlled to be 220 mm.

5. During an initial start-up or a low load operation period, and under a condition of an oxygen supplying rate being lower than a preset normal value, a number of the oxygen inlet is controlled to maintain an oxygen flow rate being 170 m/s in the oxygen inlet, and 300 m³/h of nitrogen gas are introduced into the oxygen inlet.

6. Before introducing oxygen to the hydrogen-enriched carbonic oxide recycling oxygenate furnace, a heated coal gas or a heated nitrogen gas in a high-temperature coal gas channel needs to be adjusted to more than 60% of a total air volume, and an airflow velocity in the high-temperature coal gas channel need to be adjusted being not less than 170 m/s.

7. Before the introducing the oxygen to the hydrogen-enriched carbonic oxide recycling oxygenate furnace, nitrogen gas of 700 m³/h are first introduced into an oxygen channel 1, then the oxygen is added into the oxygen channel 1, and an oxygen flow rate in the oxygen channel is maintained being 170 m/s. When the oxygen in the oxygen channel 1 increases to 90% of a set oxygen level, the nitrogen gas in the oxygen channel is gradually released, and a total flow rate in the oxygen channel is maintained being 170 m/s, which ensure a concentration of the oxygen in oxygen channel 1.

### Embodiment 3

The specific implementation method in embodiment 3 is the same as the embodiment 1, except for the following parts.

1. a diameter of the high-temperature coal gas channel 5 is 85 mm, and a total length of the tuyere sleeve is 7% of an inner diameter of a blast furnace hearth (a volume of the blast furnace is over 1000 cubic meters).

2. the oxygen outlet 3 is located at a distance of 35 mm from the tuyere front surface 8, the oxygen outlet 3 is located at an angle of 40° below a horizontal line, and a distance from the oxygen outlet 3 to a gun outlet of an inserted coal injection is 60 mm. An angle between the oxygen outlet 3 and a centerline of the tuyere sleeve is 27°.

3. the oxygen channel 1 is formed by vacuum casting in one piece. The distance between the front welding interface 9 and the oxygen outlet 3 is 30 mm, and a weld depth of the front welding interface 9 is also 30 mm.

4. During a normal operation of the hydrogen-enriched carbonic oxide recycling oxygenate furnace, an oxygen flow rate in an oxygen outlet 3 is controlled to be 160 m/s, and a distance between a front temperature zone of the tuyere body and a tuyere front surface is controlled to be 210 mm.

5. During an initial start-up or a low load operation period, and under a condition of an oxygen supplying rate being lower than a preset normal value, a number of the oxygen inlet is controlled to maintain an oxygen flow rate being 160 m/s in the oxygen inlet, and 200 m³/h of nitrogen gas are introduced into the oxygen inlet.

6. Before introducing oxygen to the hydrogen-enriched carbonic oxide recycling oxygenate furnace, a heated coal gas or a heated nitrogen gas in a high-temperature coal gas channel needs to be adjusted to more than 50% of a total air volume, and an airflow velocity in the high-temperature coal gas channel need to be adjusted being not less than 160 m/s.

7. Before the introducing the oxygen to the hydrogen-enriched carbonic oxide recycling oxygenate furnace, nitrogen gas of 600 m³/h are first introduced into an oxygen channel 1, then the oxygen is added into the oxygen channel 1, and an oxygen flow rate in the oxygen channel is maintained being 160 m/s. When the oxygen in the oxygen channel 1 increases to 80% of a set oxygen level, the nitrogen gas in the oxygen channel is gradually released, and a total flow rate in the oxygen channel is maintained being 160 m/s, which ensure a concentration of the oxygen in oxygen channel 1.

The disclosure provides the design of the tuyere sleeve, which takes into account the impact of high-temperature coal gas and the injected oxygen on the tuyere front surface. Firstly, in terms of flow rate control, it is required that the flow rate of the oxygen and the high-temperature coal gas should not be lower than 150 m/s, and it is most desirable to operate above 200 m/s. Under high-speed airflow, the high-temperature zone where the two gases react is kept away from the front end of the tuyere body, reducing the risk of tuyere damage due to burning.

In terms of the structural layout of the disclosure, the oxygen outlet is located at an angle of 30-45° below the horizontal line. Compared to the traditional method of arranging the oxygen outlet at the upper part, this layout well adapts to the spatial structure characteristics of the counterclockwise circulation formed from the bottom up at the front end of the tuyere body. The injected oxygen can quickly circulate away from the tuyere end, reducing the impact on the tuyere front surface.

The distance from the oxygen outlet to a gun outlet of an inserted coal injection is greater than or equal to 50 mm. This layout eliminates the issue of the oxygen jet from the oxygen outlet burning the gun outlet of the inserted coal injection. An angle between the oxygen outlet and the centerline of the tuyere sleeve is in a range of 25°-30°, which further eliminates the influence of the oxygen flow on the coal flow, and eliminates the issue of the oxygen flow blowing the coal powder flow and causing coal powder to wear the tuyere sleeve.

The disclosure was applied during the trial period to the 430 cubic meter hydrogen-enriched carbonic oxide recycling oxygenate furnace at Bayi Steel, where the service life of the tuyere sleeve was increased from 1 month to 3 months, and the furnace operation became more stable. It has now been promoted to the 2500 cubic meter hydrogen-enriched carbonic oxide recycling oxygenate furnace, where the service life of the tuyere sleeve has exceeded 5 months, strongly supporting the industrial production of the world's largest and only hydrogen-enriched carbonic oxide recycling oxygenate furnace.

The above is only embodiments of the disclosure, and the specific structures and characteristics commonly known in the scheme are not described in detail here. It should be pointed out that for those skilled in the art, several modifications and improvements can be made without departing from the structure of the disclosure, which should also be considered as the scope of protection of the disclosure. These will not affect the effectiveness of the implementation of the disclosure and the practicality of the disclosure. The scope of protection required by this application shall be based on the content of its claims, and the specific implementation methods and other records in the specification may be used to interpret the content of the claims.

What is claimed is:

1. A tuyere sleeve for hydrogen-enriched carbonic oxide recycling oxygenate furnace, comprising:
a tuyere body (4), a tuyere front surface (8), and an oxygen channel (1);
wherein the tuyere body (4) defines a coal gas channel (5) and a tuyere cooling water channel (6), the coal gas channel (5) is located at a center position of the tuyere body (4), the tuyere cooling water channel (6) is located at a side of the tuyere body (4), and a front end of the tuyere body (4) is welded to a front welding interface (9) with the tuyere front surface (8);
wherein a diameter of the coal gas channel (5) is in a range of 50 millimeters (mm)-120 mm;
wherein a total length of the tuyere sleeve is in a range of 6%-8% of an inner diameter of a blast furnace hearth;
wherein the oxygen channel (1) is defined inside the tuyere body (4), and the oxygen channel (1) extends from an inner side of the front end of the tuyere body (4); the tuyere body (4) defines an oxygen inlet (2) and an oxygen outlet (3) at two ends of the oxygen channel (1), respectively; the oxygen outlet (3) is located at a distance of 20 mm-50 mm from the tuyere front surface (8), the oxygen outlet (3) is located at an angle of 30°-45° below a horizontal line, and a distance from the oxygen outlet (3) to a gun outlet of an inserted coal injection is greater than or equal to 50 mm; an angle between the oxygen outlet (3) and a centerline of the tuyere sleeve is in a range of 25°-30°.

2. The tuyere sleeve for hydrogen-enriched carbonic oxide recycling oxygenate furnace as claimed in claim 1, wherein a distance between the front welding interface (9) and the oxygen outlet (3) is not less than 20 mm, and a weld depth of the front welding interface (9) is not less than 20 mm.

3. The tuyere sleeve for hydrogen-enriched carbonic oxide recycling oxygenate furnace as claimed in claim 1, wherein after the front welding interface (9) is a welded, a temperature and wear-resistant protective layer is welded to the front welding interface (9).

4. A controlling method for a tuyere sleeve for hydrogen-enriched carbonic oxide recycling oxygenate furnace, comprising:
during a normal operation of the hydrogen-enriched carbonic oxide recycling oxygenate furnace, controlling an oxygen flow rate in an oxygen outlet (3) to be not less than 150 meters per second (m/s), and controlling a distance between a front temperature zone of the tuyere body (4) and a tuyere front surface (8) to be not less than 200 mm.

5. The controlling method for the tuyere sleeve for hydrogen-enriched carbonic oxide recycling oxygenate furnace as claimed in claim 4, further comprising:
during an initial start-up or a load operation period, and under a condition of an oxygen supplying rate being lower than a preset normal value, controlling a number of the oxygen inlet (2) to maintain an oxygen flow rate being not less than 150 m/s in the oxygen inlet (2), and introducing 100-300 m³/h of nitrogen gas into the oxygen inlet (2).

6. The controlling method for the tuyere sleeve for hydrogen-enriched carbonic oxide recycling oxygenate furnace as claimed in claim 4, further comprising:
before introducing oxygen to the hydrogen-enriched carbonic oxide recycling oxygenate furnace, adjusting a heated coal gas or a heated nitrogen gas in a coal gas channel (5) to more than 40% of a total air volume, and adjusting an airflow velocity in the coal gas channel (5) being not less than 150 m/s.

7. The controlling method for the tuyere sleeve for hydrogen-enriched carbonic oxide recycling oxygenate furnace as claimed in claim 6, further comprising:
before the introducing oxygen to the hydrogen-enriched carbonic oxide recycling oxygenate furnace, first introducing nitrogen gas of not being less than 500 m³/h into an oxygen channel (1), adding the oxygen into the oxygen channel (1), and maintaining an oxygen flow rate in the oxygen channel (1) being not less than 150 m/s; when the oxygen in the oxygen channel (1) increases to more than 70% of a set oxygen level, gradually releasing the nitrogen gas in the oxygen channel (1), and maintaining a total flow rate in the oxygen channel (1) not being less than 150 m/s.
